(19) United States
(12) Patent Application Publication
(10) Pub. No.: US 2026/0244019 A1
(43) Pub. Date: Aug. 20, 2026

(54) OPTICAL SYSTEM FOR A VIRTUAL RETINAL SCAN DISPLAY

(71) Applicant: Robert Bosch GmbH, Stuttgart (DE)

(72) Inventors: Christian Adam Grafenburg, Stuttgart (DE); Moritz Esslinger, Leonberg (DE)

(21) Appl. No.: 19/164,235

(22) PCT Filed: Jun. 4, 2024
(86) PCT No.: PCT/EP2024/065281

§ 371 Date: Sep. 11, 2025

(30) Foreign Application Priority Data
Jun. 28, 2023 (DE) 10 2023 206 113.9

(51) Int. Cl. G02B 27/01; G02B 27/42

(52) U.S. Cl. CPC G02B 27/0172; G02B 27/4227; G02B 27/4261; G02B 27/4283; G02B 2027/0109; G02B 2027/0174; G02B 2027/0178

(57) ABSTRACT

An optical system for a virtual retinal scan display including an illumination device. The illumination device includes: a first laser diode for emitting a first light beam within a first wavelength range, the first wavelength range shifting toward a second wavelength range depending on a temperature of the first laser diode; a first controllable deflection unit for the first light beam for scanning projection of the image content; and a holographic optical element for deflecting the first light beam onto an eye. The holographic optical element is made of liquid crystals and has a first holographic function with a first diffraction efficiency range and a second holographic function with a second diffraction efficiency range. The optical system includes a control unit which controls the holographic optical element or a polarization switch depending on acquired information about the first or second wavelength range of the emitted first light beam.

### FIELD

The present invention relates to an optical system for a virtual retinal scan display. The present invention also relates to a method for controlling a holographic optical element or a polarization switch of an optical system for a virtual retinal scan display.

### BACKGROUND INFORMATION

Certain smart glasses with retinal scan displays and holographic optical elements for deflecting light beams onto the eye are described in the related art.

It is an object of the present invention to develop an optical system for a virtual retinal scan display with a holographic optical element for deflecting light beams onto the eye which continues to function even when the temperature of the laser diode of the optical system fluctuates.

### SUMMARY

An optical system for a virtual retinal scan display having certain features of the present invention, and a method for controlling a holographic optical element or a polarization switch of an optical system for a virtual retinal scan display having certain features of the present invention, are provided.

According to an example embodiment of the present invention, the optical system for a virtual retinal scan display comprises at least one illumination device, which is in particular configured as a projector unit, for example a microprojector unit. The illumination device comprises at least one first laser diode for emitting a first light beam within a first wavelength range. The first wavelength range shifts toward a second wavelength range depending on a temperature of the first laser diode, in particular the temperature of at least one first laser cavity of the first laser diode. The laser diode can heat up during operation, for example, in particular due to the laser power. The optical system further comprises a first controllable deflection unit for the first light beam for scanning projection of the image content. The optical system also comprises a holographic optical element, in particular configured as a layer, for deflecting the first light beam incident on the holographic optical element from the controllable deflection unit onto an eye. The eye is in particular the eye of a user of the optical system. The holographic optical element is made of liquid crystals. In this context, the holographic optical element is in particular used as an LCD hologram. Such liquid crystals are characterized by an anisotropic refractive index. The holographic optical element has a first holographic function with a first diffraction efficiency range and a second holographic function with a second diffraction efficiency range. The first wavelength range here at least partly overlaps the first diffraction efficiency range and the second wavelength range at least partly overlaps the second diffraction efficiency range. The first wavelength range in particular overlaps the first diffraction efficiency range completely and the second wavelength range overlaps the second diffraction efficiency range completely. The holographic optical element is preferably embedded in a lens, in particular a spectacle lens, of the optical system. The optical system further comprises a sensor for acquiring at least one item of information about the, in particular current first or second wavelength range of the emitted first light beam. The first sensor is preferably configured as a temperature sensor. The optical system also comprises a control unit. In this context, the control unit serves to control the holographic optical element depending on the acquired information about the, in particular current, first or second wavelength range of the emitted first light beam in such a way that the first light beam with the first wavelength, which is incident on the holographic optical element at a first time with a first angle of incidence, and the first light beam with the second wavelength, which is incident at a second time following the first time with the first angle of incidence, are deflected toward the eye. The light beam is in particular deflected to the same positions of the eye at the first and second time. The angle of incidence selectivity of the first and second holographic function is thus the same for both wavelengths. Alternatively or additionally, the optical system comprises a polarization switch for switching the first light beam to a first or a second polarization direction. The first light beam with the first polarization direction is assigned to the first diffraction efficiency range and the first light beam with the second polarization direction is assigned to the second diffraction efficiency range of the holographic optical element. This means that only first light beams with the first polarization direction are deflected within the first diffraction efficiency range and only first light beams with the second polarization direction are deflected within the second diffraction efficiency range. The polarization switch is preferably made of a liquid crystal and a polarization filter. In this context, the control unit is configured to control the polarization switch depending on the acquired information about the, in particular current, first or second wavelength range of the emitted first light beam in such a way that the first light beam with the first wavelength, which is incident on the holographic optical element at the first time with the first angle of incidence, and the first light beam with the second wavelength, which is incident at the second time following the first time with the first angle of incidence, are deflected toward the eye, in particular the same positions of the eye. In both cases, the anisotropy of the holographic optical element is used to enable the optical system to function even when the temperature of the laser diode fluctuates.

The control unit is preferably configured to use a lookup table to determine the first or second wavelength range associated with the current temperature of the first laser diode. The first sensor is alternatively configured as a first optical spectrometer. The control unit can directly use the spectral data acquired in this way to determine the, in particular current, first or second wavelength range.

According to an example embodiment of the present invention, the holographic optical element is preferably configured as an, in particular static, holographic optical element which has the first and the second diffraction efficiency range at the first and at the second time. Such a holographic optical element with an anisotropic refractive index always exhibits different diffraction efficiency ranges in the three spatial directions x, y and z of the liquid crystals. The holographic optical element exhibits different holographic functions, in particular for x- and y-polarized light. The diffraction efficiency (for a specific angle of incidence/diffraction angle configuration) can thus be set or recorded at different wavelengths depending on the polarization of the incident light. The holographic optical element is alternatively configured as rotatable, in particular twistable, liquid crystals. Each state, in particular rotation angle, of the liquid crystals is then assigned a different diffraction efficiency range of the holographic optical element. In this context, the control unit is configured to control the liquid crystals in such a way that the holographic optical element has only the first diffraction efficiency range at the first time and only the second diffraction efficiency range at the second time. This could enable continuous tracking of the holographic optical element to the shift in the laser wavelength.

According to an example embodiment of the present invention, the optical system preferably also comprises a second laser diode for emitting a second light beam with a second wavelength and with the second polarization direction. In this context, the first laser diode is configured to emit the first light beam with the first polarization direction. The control unit is configured to switch off the first laser diode and switch on the second laser diode, in particular at the second time, depending on the acquired information about the, in particular current, first or second wavelength range of the emitted first light beam. The first light beam with the first polarization direction is in particular assigned to the first diffraction efficiency range and the second light beam with the second polarization direction is assigned to the second diffraction efficiency range of the holographic optical element. The polarization switch can thus be omitted and the control unit decides which of the two laser diode light beams is switched on and switched off depending on the acquired information about the, in particular current, first or second wavelength range.

The polarization switch is preferably made of a liquid crystal and a polarization filter.

The polarization switch is preferably disposed in the beam direction of the first light beam between the first laser diode and other optical components, in particular lenses, of the optical system.

The optical system is preferably configured as smart glasses, in particular as augmented reality glasses or virtual reality glasses.

A further subject matter of the present invention is a method for controlling a holographic optical element or a polarization switch of an optical system for a virtual retinal scan display. The optical system for the virtual retinal scan display has been described above. According to an example embodiment of the present invention, in this method, a laser diode of the optical system first emits a first light beam within a first wavelength range. The first wavelength range shifts toward a second wavelength range depending on a temperature of the first laser diode, in particular the temperature of at least one first laser cavity of the first laser diode. In a further method step, the information about the, in particular current, first or second wavelength range of the emitted first light beam is acquired by means of the control unit. The holographic optical element or the polarization filter of the optical system are furthermore controlled by the control unit depending on the acquired information about the, in particular current, first or second wavelength range of the emitted first light beam in such a way that the first light beam with the first wavelength, which is incident on the holographic optical element at a first time with a first angle of incidence, and the first light beam with the second wavelength, which is incident at a second time following the first time with the first angle of incidence, are deflected toward the eye, in particular the same positions of the eye. The method thus ensures that the optical system continues to function even when the temperature of the laser diode fluctuates.

The temperature of the first laser diode, in particular the temperature of at least the first laser cavity of the first laser diode, preferably represents the information about the, in particular current, first or second wavelength range of the emitted first light beam.

The first wavelength range and the second wavelength range preferably differ from one another by at least 2 nm, in particular at least 5 nm, at their maxima. The maxima refer in particular to the centers of gravity or peaks of the respective wavelength ranges.

The first and second diffraction efficiency ranges preferably partly overlap. This ensures that there are no gaps between the diffraction efficiency ranges and thus no regions with incorrect or no deflection of the light beams onto the eye.

The first polarization direction of the first light beam and the second polarization direction of the first light beam are preferably disposed orthogonally to one another. The polarization switch is in particular configured to polarize the first light beam with the first wavelength in x-direction and the first light beam with the second wavelength in y-direction. Alternatively, the polarization switch is configured to make the first light beam with the first wavelength left-circular and the first light beam with the second wavelength right-circular.

According to an example embodiment of the present invention, a second laser diode for emitting a second light beam with a second wavelength and with the second polarization direction is preferably switched on by means of the control unit as well, in particular at the second time, depending on the acquired information about the, in particular current, first or second wavelength range of the emitted first light beam. The first laser diode is furthermore switched off by means of the control unit, in particular at the second time. The first laser diode serves here to emit the first light beam with the first polarization direction. The correspondingly different polarization of the light beam thus takes place independently of the polarization switch.

### BRIEF DESCRIPTION OF THE DRAWINGS

FIG. 1 shows a first example embodiment of an optical system for a virtual retinal scan display, according to the present invention.

FIG. 2 shows a second example embodiment of the optical system for the virtual retinal scan display, according to the present invention.

FIG. 3 shows a third example embodiment of the optical system for the virtual retinal scan display, according to the present invention.

FIG. 4 shows the overlap of wavelength ranges of the first light beam with the corresponding diffraction efficiency ranges of the holographic optical element, according to an example embodiment of the present invention.

FIG. 5 shows a method for controlling a holographic optical element of an optical system for a virtual retinal scan display, according to an example embodiment of the present invention.

FIG. 6 shows a method for controlling a polarization switch of an optical system for a virtual retinal scan display, according to an example embodiment of the present invention.

### DETAILED DESCRIPTION OF EXAMPLE EMBODIMENTS

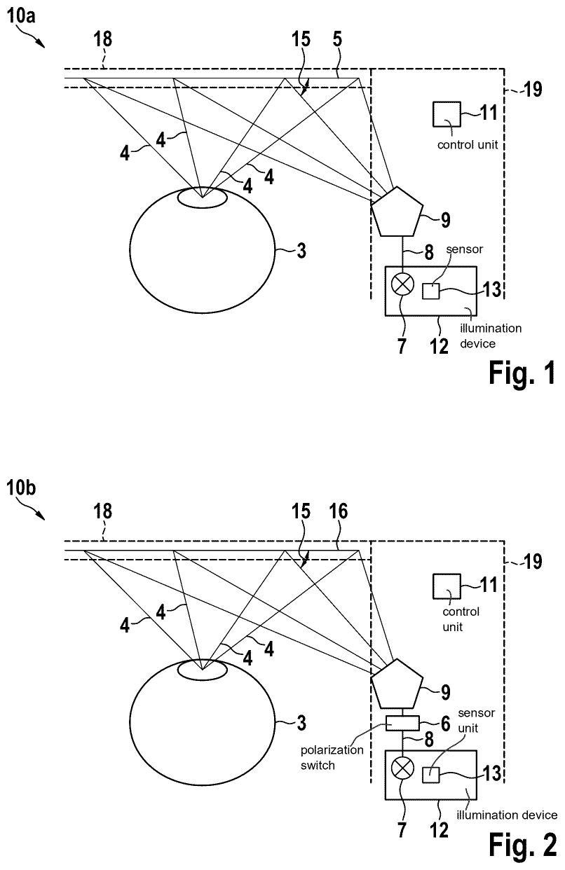

FIG. 1 schematically shows an optical system 10a for a virtual retinal scan display. The optical system 10a is configured here as smart glasses with a side piece 19 and a spectacle lens 18. The optical system 10a comprises an illumination device 12, which in this case is configured as a projector unit of the optical system 10a. The illumination device 12 in turn comprises a first laser diode 7 for emitting a first light beam 8 within a first wavelength range. The first wavelength range shifts toward a second wavelength range depending on a temperature of the first laser diode 7, in particular the temperature of at least one first laser cavity of the first laser diode 7. The optical system 10a further comprises a first controllable deflection unit 9 for the first light beam 8 for scanning projection of the image content. The controllable deflection unit 9 is in particular configured as a micromirror that is mounted such that it can rotate in two dimensions. Alternatively, the controllable deflection unit is made of two micromirrors, each of which is mounted such that it can rotate in one dimension. The optical system 10a further comprises a holographic optical element 5 for deflecting the first light beam 8 incident on the holographic optical element 5 from the controllable deflection unit 9 onto an eye 3. The eye 3 here is the eye 3 of a user of the smart glasses as the optical system 10a. The holographic optical element 5 is made of liquid crystals and has a first holographic function with a first diffraction efficiency range and a second holographic function with a second diffraction efficiency range. The first wavelength range at least partly overlaps the first diffraction efficiency range and the second wavelength range at least partly overlaps the second diffraction efficiency range. In this embodiment example, the holographic optical element 5 is integrated, in particular embedded, in a spectacle lens 18. The lens 18 is configured as a spectacle lens of the optical system 10a. The optical system 10a further comprises a sensor 13 for acquiring at least one item of information about the, in particular current first or second wavelength range of the emitted first light beam 8. In this embodiment, the sensor 13 is configured as a temperature sensor. The optical system 10a also comprises a control unit 11. In the shown embodiment of the optical system 10a, the projector unit 12, the controllable deflection unit 9, and the control unit 11 are integrated into the side piece 19. In this context, the control unit 11 is configured to control the holographic optical element 5 depending on the acquired information about the, in particular current, first or second wavelength range of the emitted first light beam 8 in such a way that the first light beam 8 with the first wavelength, which is incident on the holographic optical element 5 at a first time with a first angle of incidence 15, and the first light beam 8 with the second wavelength, which is incident at a second time following the first time with the first angle of incidence 15, are deflected toward the eye 3. The first light beams 8 are in particular deflected to the same positions 4 of the eye 3 at the first and second time.

The control unit 11 is in particular configured to use a lookup table to determine the first or second wavelength range associated with the current temperature of the first laser diode. The first sensor 13 is alternatively configured as a first optical spectrometer. The control unit 11 can directly use the spectral data acquired in this way to determine the, in particular current, first or second wavelength range.

In this first embodiment, the holographic optical element 5 is configured as rotatable, in particular twistable, liquid crystals. Each state, in particular rotation angle, of the liquid crystals is then assigned a different diffraction efficiency range of the holographic optical element 5. The control unit 11 serves to control the liquid crystals in such a way that the holographic optical element 5 has only the first diffraction efficiency range at the first time and only the second diffraction efficiency range at the second time.

FIG. 2 schematically shows a second embodiment of an optical system 10b. In contrast to the first embodiment, the optical system 10b here additionally comprises a polarization switch 6. The polarization switch 6 is configured to switch the first light beam 8 to a first or a second polarization direction. The first polarization direction of the first light beam and the second polarization direction of the first light beam are optionally disposed orthogonally to one another here. The first light beam 8 with the first polarization direction is assigned to the first diffraction efficiency range and the first light beam with the second polarization direction is assigned to the second diffraction efficiency range of the holographic optical element 16. In this context, the control unit 11 serves to control the polarization switch 6 depending on the acquired information about the, in particular current, first or second wavelength range of the emitted first light beam 8 in such a way that the first light beam 8 with the first wavelength and the first polarization direction, which is incident on the holographic optical element 16 at a first time with a first angle of incidence 15, and the first light beam 8with the second wavelength and the second polarization direction, which is incident at a second time following the first time with the first angle of incidence 15, are deflected toward the eye. The first light beams 8 are in particular deflected to the same positions 4 of the eye 3 at the first and second time.

In contrast to the first embodiment of the optical system 10a, the holographic optical element 16 is configured as a holographic optical element 16, which has both the first and the second diffraction efficiency range at the first and at the second time. Such a holographic optical element 16 can also be referred to as a static holographic optical element 16.

The polarization switch 6 in the shown embodiment is made of a liquid crystal and a polarization filter. The polarization switch 6 is disposed in the beam direction of the first light beam 8 between the first laser diode 7 and other optical components, in particular lenses, of the optical system 10b, which are not shown here for the sake of simplicity.

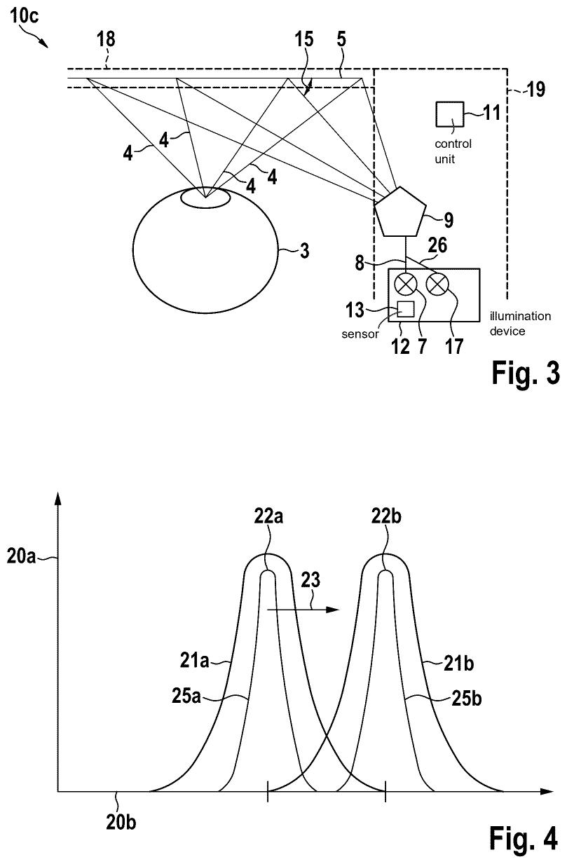

FIG. 3 schematically shows a third embodiment of an optical system 10c. In contrast to the first embodiment, the optical system 10c here additionally comprises a second laser diode 17 for emitting a second light beam 26 with the second wavelength and with the second polarization direction. In this context, the first laser diode 7 is configured to emit the first light beam 8 with a first polarization direction. The control unit 11 serves to switch off the first laser diode 7 and switch on the second laser diode 17, in particular at the second time, depending on the acquired information about the, in particular current, first or second wavelength range of the emitted first light beam 8.

FIG. 4 uses a diagram to show the assignment of the first wavelength range 25a to the first diffraction efficiency range 21a and the second wavelength range 25b to the second diffraction efficiency range 21b. The laser power of the first and second laser diodes is plotted on the first y-axis 20a. The wavelength is plotted on the x-axis 20b. The first wavelength range 25a of the first light beam of the first laser diode shifts in the direction of the arrow 23 from the first time to the second time due to an increase in the temperature of the first laser diode to the higher, second wavelength range 25b. The different diffraction efficiency ranges 21a and 21b of the holographic optical element ensure that the first light beams are always correctly deflected onto the eye of the user of the optical system.

Optionally, a first polarization direction of the first light beam is assigned to the first diffraction efficiency range 21a, and a second polarization direction of the first light beam is assigned to the second diffraction efficiency range 21b.

In the case shown, the first wavelength range 25a and the second wavelength range 25 b differ from one another by substantially 2 nm at their maxima 22a and 22b. The first diffraction efficiency range 21a and the second diffraction efficiency range 21b moreover partly overlap one another.

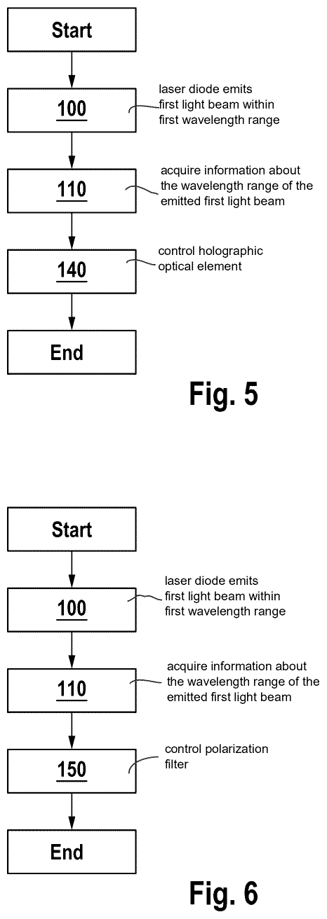

FIG. 5 shows a method for controlling a holographic optical element of an optical system for a virtual retinal scan display. The optical system is in particular the optical system shown in FIG. 1. In the method, in method step 100, a laser diode of the optical system first emits a first light beam within a first wavelength range. The first wavelength range shifts toward a second wavelength range depending on a temperature of the first laser diode, in particular the temperature of at least one first laser cavity of the first laser diode. In a further method step 110, information about the, in particular current, first or second wavelength range of the emitted first light beam is acquired by means of the control unit of the optical system. In a method step 140, the holographic optical element of the optical system are further controlled by the control unit depending on the acquired information about the, in particular current, first or second wavelength range of the emitted first light beam in such a way that the first light beam with the first wavelength, which is incident on the holographic optical element at a first time with a first angle of incidence, and the first light beam with the second wavelength, which is incident at a second time following the first time with the first angle of incidence, are deflected toward the eye, in particular the same positions of the eye. The method is then terminated.

The temperature of the first laser diode optionally represents the information about the, in particular current, first or second wavelength range of the emitted first light beam. This is in particular the temperature of at least the first laser cavity of the first laser diode. To determine the currently present first or second wavelength of the first light beam, the control unit optionally accesses a lookup table in which the temperatures of the first laser diode and the associated first or second wavelength of the emitted first light beam are stored. The first sensor is alternatively configured as a first optical spectrometer. The control unit can directly use the spectral data acquired in this way to determine the, in particular current, first or second wavelength range.

FIG. 6 shows a method for controlling a polarization switch of an optical system for a virtual retinal scan display. In contrast to the method in FIG. 5, in a method step 150 following method step 110, the polarization filter of the optical system is controlled by the control unit depending on the acquired information about the, in particular current, first or second wavelength range of the emitted first light beam in such a way that the first light beam with the first wavelength, which is incident on the holographic optical element at a first time with a first angle of incidence, and the first light beam with the second wavelength, which is incident at a second time following the first time with the first angle of incidence, are deflected toward the eye, in particular the same positions of the eye. The polarization switch is configured to switch the first light beam with the first wavelength to a first polarization direction at the first time and the first light beam with the second wavelength to a second polarization direction at the second time. The first polarization direction is assigned to the first diffraction efficiency range of the holographic optical element and the second polarization direction is assigned to the second diffraction efficiency range of the holographic optical element.

1-15. (canceled)

16. An optical system for a virtual retinal scan display, comprising:
an illumination device including a projector unit, wherein the illumination device includes at least one first laser diode configured to emit a first light beam within a first wavelength range, wherein the first wavelength range shifts toward a second wavelength range depending on a temperature of at least one first laser cavity of the first laser diode, and
a first controllable deflection unit for the first light beam configured for scanning projection of image content; and
a holographic optical element configured to deflect the first light beam incident on the holographic optical element from the first controllable deflection unit onto an eye of a user of the optical system, wherein the holographic optical element is made of liquid crystals, and the holographic optical element includes a first holographic function with a first diffraction efficiency range and a second holographic function with a second diffraction efficiency range, wherein the first wavelength range at least partly overlaps the first diffraction efficiency range and the second wavelength range at least partly overlaps the second diffraction efficiency range;
a sensor configured to acquire at least one item of information about a current first or second wavelength range of the emitted first light beam; and:
(i) a control unit, and/or (ii) a polarization switch for switching the first light beam to a first or a second polarization direction, wherein the first light beam with the first polarization direction is assigned to the first diffraction efficiency range and the first light beam with the second polarization direction is assigned to the second diffraction efficiency range of the holographic optical element;
wherein the control unit is configured to control the holographic optical element or the polarization switch depending on the acquired information about the current first or second wavelength range of the emitted first light beam in such a way that the first light beam with a first wavelength within the first wavelength range, which is incident on the holographic optical element at a first time with a first angle of incidence, and the first light beam with a second wavelength within the second wavelength range, which is incident at a second time following the first time with the first angle of incidence, are deflected toward the same positions of the eye.

17. The optical system according to claim 16, wherein the holographic optical element is configured as a static holographic optical element, which has the first and the second diffraction efficiency range at the first and at the second time.

18. The optical system according to claim 16, wherein the holographic optical element is configured as rotatable liquid crystals, wherein each rotation angle of the liquid crystals is assigned a different diffraction efficiency range of the holographic optical element, wherein the control unit is configured to control the liquid crystals in such a way that the holographic optical element has only the first diffraction efficiency range at the first time and only the second diffraction efficiency range at the second time.

19. The optical system according to claim 16, wherein the first sensor is configured as a temperature sensor.

20. The optical system according to claim 16, wherein the optical system also includes a second laser diode for emitting a second light beam with the second wavelength and with the second polarization direction, wherein the first laser diode is configured to emit the first light beam with the first polarization direction, wherein the control unit is configured to switch off the first laser diode and switch on the second laser diode at the second time, depending on the acquired information about the current first or second wavelength range of the emitted first light beam.

21. The optical system according to claim 16, wherein the holographic optical element is embedded in a spectacle lens of the optical system.

22. The optical system according to claim 16, wherein the polarization switch is made of a liquid crystal and a polarization filter.

23. The optical system according to claim 16, wherein the polarization switch is disposed in a beam direction of the first light beam between the first laser diode and other optical components including lenses of the optical system.

24. The optical system according to claim 16, wherein the optical system is configured as smart glasses.

25. A method for controlling a holographic optical element or a polarization switch of an optical system for a virtual retinal scan display, the optical system including:
an illumination device including a projector unit of the optical system, wherein the illumination device includes at least one first laser diode configured to emit a first light beam within a first wavelength range, wherein the first wavelength range shifts toward a second wavelength range depending on a temperature of at least one first laser cavity of the first laser diode;
a first controllable deflection unit or the first light beam for a scanning projection of image content;
the holographic optical element configured to deflect the first light beam incident on the holographic optical element from the controllable deflection unit onto an eye of a user of the optical system, wherein the holographic optical element is made of liquid crystals, and the holographic optical element includes a first holographic function with a first diffraction efficiency range and a second holographic function with a second diffraction efficiency range, wherein the first wavelength range at least partly overlaps the first diffraction efficiency range and the second wavelength range at least partly overlaps the second diffraction efficiency range;
a sensor configured to acquire at least one item of information about a current first or second wavelength range of the emitted first light beam; and:
(i) a control unit, and/or
(ii) the polarization switch for switching the first light beam to a first or a second polarization direction, wherein the first light beam with the first polarization direction is assigned to the first diffraction efficiency range and the first light beam with the second polarization direction is assigned to the second diffraction efficiency range of the holographic optical element;
wherein the method comprises the following steps:
emitting the first light beam using the first laser diode;
acquiring the information about the current first or second wavelength range of the emitted first light beam using the control unit; and
controlling the holographic optical element or the polarization filter of the optical system depending on the acquired information about the current first or second wavelength range of the emitted first light beam using the control unit in such a way that the first light beam with a first wavelength within the first wavelength range, which is incident on the holographic optical element at a first time with a first angle of incidence, and the first light beam with a second wavelength within the second wavelength range, which is incident at a second time following the first time with the first angle of incidence, are deflected toward the same positions of the eye.

26. The method according to claim 25, wherein the temperature of the first laser cavity of the first laser diode represents information about ther current first or second wavelength range of the emitted first light beam.

27. The method according to claim 25, wherein the first wavelength range and the second wavelength range differ from one another by at least 2 nm at their maxima center of gravity.

28. The method according to claim 25, wherein the first and the second diffraction efficiency range partly overlap.

29. The method according to claim 25, wherein the first polarization direction of the first light beam and the second polarization direction of the first light beam are disposed orthogonally to one another.

30. The method according to claim 25, further comprising the following method steps:
switching only a second laser diode for emitting a second light beam with the second wavelength and with the second polarization direction using the control unit at the second time, depending on the acquired information about the current first or second wavelength range of the emitted first light beam; and
switching off the first laser diode using the control unit at the second time, wherein the first laser diode is configured to emit the first light beam with the first polarization direction.
